(19) United States
(12) Patent Application Publication
(10) Pub. No.: US 2015/0019372 A1
(43) Pub. Date: Jan. 15, 2015

(54) Method and system for customizing sandals for a user

(71) Applicant: Terral Fox, Cedar City, UT (US)

(72) Inventor: Terral Fox, Cedar City, UT (US)

(21) Appl. No.: 14/331,954

(22) Filed: Jul. 15, 2014

Related U.S. Application Data
(60) Provisional application No. 61/846,182, filed on Jul. 15, 2013.

(51) Int. Cl. G06Q 30/06; A43D 8/00; A43B 3/12

(52) U.S. Cl. CPC G06Q 30/0621; A43B 3/122; A43B 3/128; A43D 8/00
USPC 705/26.5; 12/103; 12/142 S

(57) ABSTRACT

In one embodiment, a method and system for customizing sandals comprises providing a user with a series of foot sole templates embodying varying shapes and sizes from which the user selects their foot shape; providing a second template for the selected shape with a series of possible positions for the placement of a toe strap; and manufacturing the sandal according to the user selections.

### CROSS-REFERENCE TO RELATED APPLICATIONS

This application claims the benefit of U.S. Provisional Application Ser. No. 61/846,182, filed on Jul. 15, 2013, which is incorporated herein by reference.

### TECHNICAL FIELD

The present disclosure relates to shoes. More particularly, the present disclosure relates to methods and systems for customizing sandals and/or flip-flops for a user.

### BACKGROUND

A common problem for people when buying sandals is the inability of the user to easily customize the sandal to fit a user's foot. Most sandals have a standard shape (although some brands offer a “wide” category) and, depending on style, a standard placement with the strap between the hallux (aka the “big toe”) and the second toe. However, feet come in many different sizes and shapes, making the one-shape-fits-all standards inadequate. As a result, users who don't fit the standard shape must either suffer with discomfort or avoid buying sandals.

Further, a user desiring minimalist sandals (defined as a very thin sole) is in need of a customized sandal to prevent the front sole portion of the sandal from snagging the ground and folding, bending, and possibly causing a user to trip.

The present invention seeks to solve these and other problems.

### SUMMARY OF EXAMPLE EMBODIMENTS

In one embodiment, a method and system for customizing sandals comprises providing a user with a series of foot sole templates embodying varying shapes and sizes from which the user selects their foot shape; and manufacturing the sandal according to the user selections.

In another embodiment, a method and system for customizing sandals comprises providing a user with a series of foot sole templates embodying varying shapes and sizes from which the user selects their foot shape; providing a second template for the selected shape with a series of possible positions for the placement of a toe strap; and manufacturing the sandal according to the user selections.

In another embodiment, a method and system for customizing sandals comprises providing a user with a template with a plurality of overlapping shapes and sizes from which the user selects their foot shape; providing a series of possible positions for the placement of the toe strap; and manufacturing the sandal according to the user selections.

In yet another embodiment, a user, after determining size and placement, uses a computing device, such as a personal computer or smartphone, to make the appropriate selections and place their order online.

### BRIEF DESCRIPTION OF THE DRAWINGS

FIG. 1 illustrates a foot sole template with varying foot shapes

FIG. 2 illustrates a foot sole template without a toe strap

FIG. 3 illustrates a foot sole template allowing a user to select the position of a toe strap

FIG. 4 illustrates a template comprising a plurality of overlaid sole templates

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

Further it should be noted that although references are made to “shoes,” “sandals,” or “flip flops,” they may used interchangeably and the present invention is not limited to any singular embodiment. Also, the term “strap positioning” may refer to the position of the “toe” strap, such as one that connects to the sole of a sandal between the big toe and second toe, or to the position of a strap that engages the apertures on the sides of the sole of the sandal.

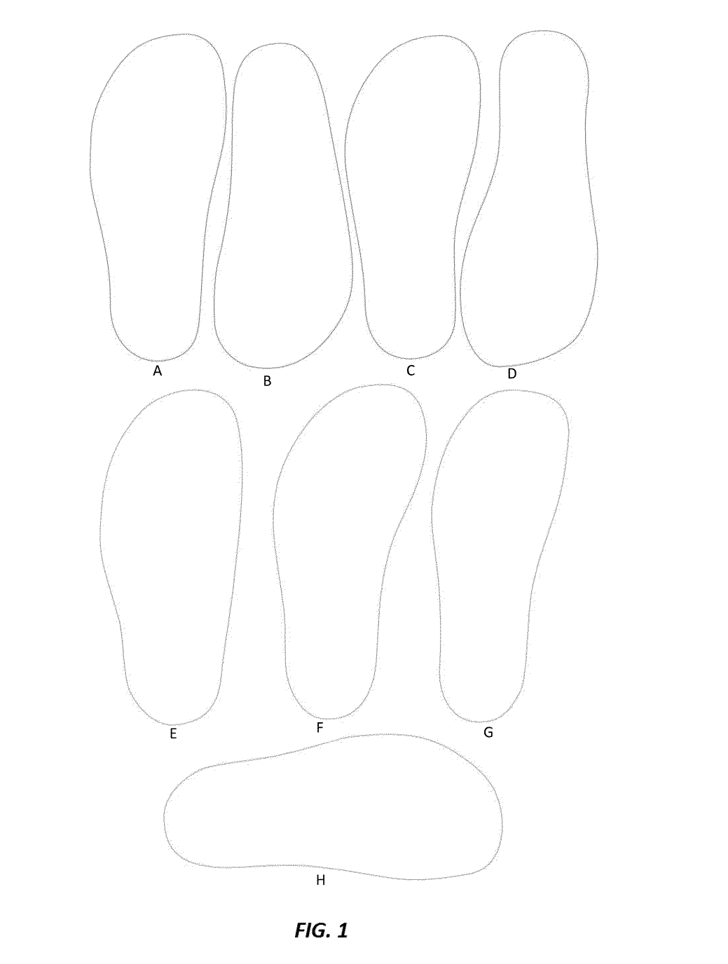

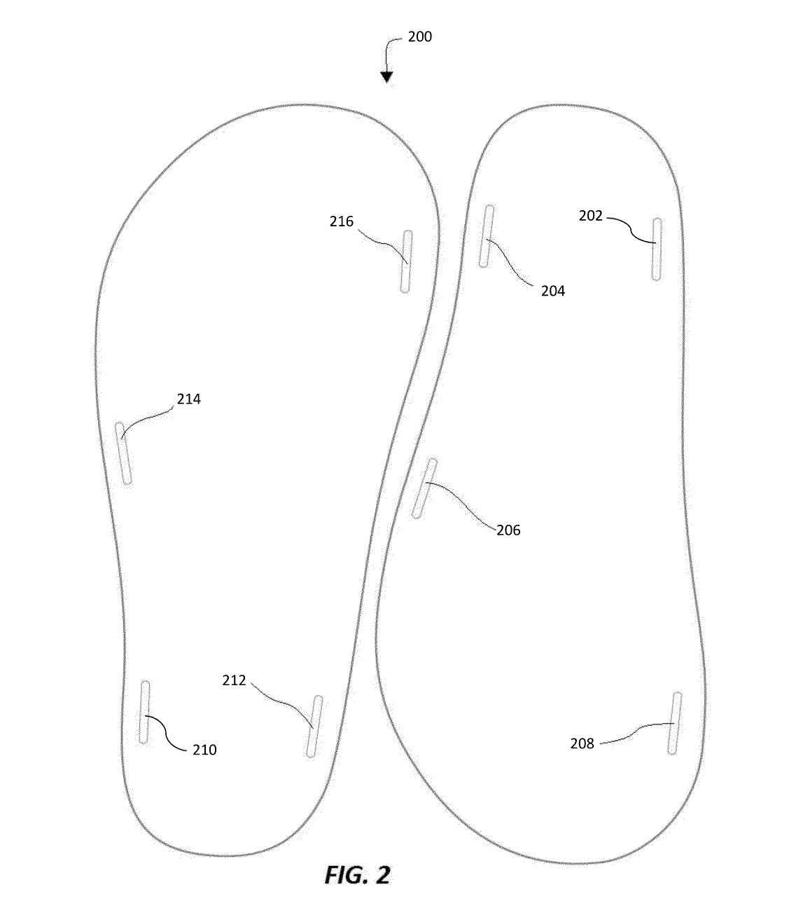

The present disclosure is directed to systems and methods of customizing sandals for user. In general, as illustrated in FIG. 1, in one embodiment, a user is presented with a plurality of templates, such as templates labeled A-H in FIG. 1, illustrating various shapes of feet. A user then either selects the known shape of their foot, or otherwise determines the shape of their foot (for example, by standing thereon to compare them to their feet). It will be appreciated that the templates may be printed on paper, but may also be formed from plastics, metals, or other materials that allow for a user to stand thereon and compare shape and/or size. Once a user has determined the size and shape of their foot, they select the materials and/or colors and the sandal is manufactured. In another embodiment, a user may also be presented with further templates allowing for confirmation of shape and customization of strap placement, as shown in FIG. 2.

FIG. 2 illustrates foot sole template 200 comprising a plurality of strap apertures 202-216. In one embodiment, a user may select from a plurality of strap apertures 202-216 for optimal placement. It will be appreciated that more or less apertures may also be used, and that changing the amount of apertures does not depart herefrom.

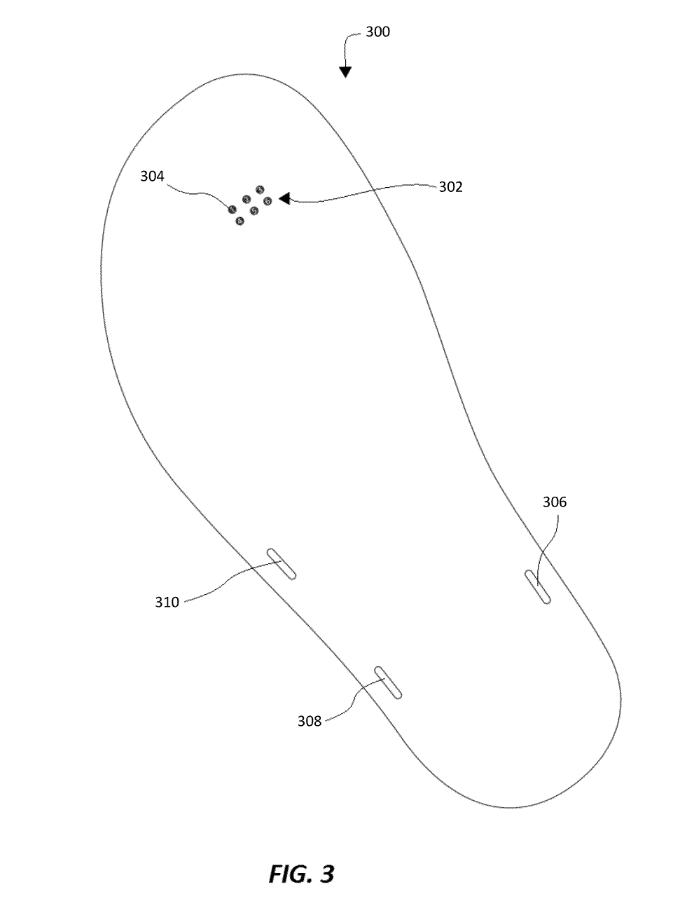

In yet another embodiment, as illustrated in FIG. 3, a foot template 300 comprises a selecting means 302 for selecting the position of a toe strap. Selecting means 302 comprises a series of position identifiers 304, such as numbers, letters, shapes, or other identifiable means. When a user desires to customize a sandal, the user places their foot on template 300 and selects the best placement for the toe strap using selecting means 302. This allows users to obtain optimal placement of the toe strap. For example, when a first user places their foot on template 300, they may find that the space between the big toe and second toe is optimally aligned with number 6 of position identifiers 304, while a second user may find number 4 optimal. Because feet vary from user to user, this system allows for greater customization and comfort for a given user. Foot template 300 may further comprise at least one strap aperture 306, 308, 310 for further customization. For example, one user may desire to have a strap coupled with aperture 306 as opposed to 308, while another user may prefer the strap more secured to the ankle using 308.

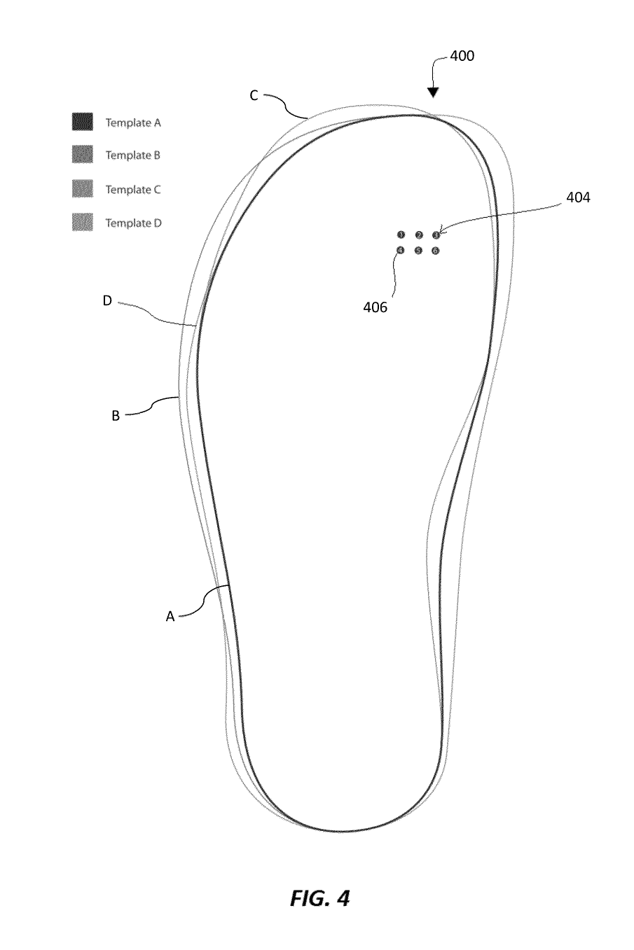

In another embodiment, as illustrated in FIG. 4, a method and system for customizing sandals comprises providing a user with a template 400 which comprises a plurality of foot sole templates A-D overlaid one with another (and identifiable by using either colors, shades, broken lines, a key box, etc.) and selecting means 404, which is further comprised of a series of position identifiers 406. For example, a user may simultaneously select a foot template A-D as well as the appropriate toe strap placement using selecting means 404.

In another embodiment, a user may also make other selections to further customize their sandal, such as thickness of the sole, material from which the sole is made, strap materials and whether the straps are adjustable, and coloring.

In one embodiment, a user is presented with a series of computing screens, such as on a personal computer or smartphone, from which they make their selections. A user is given the ability to print various templates as needed to ascertain foot shape and placement. The user progresses through the series of screens until the sandal is finalized and ready for manufacturing. However, in another embodiment, a user makes selections from physical templates, for example, at a retail store for instant assembly of the sandal.

What is claimed is:

1. A system for customizing sandals, comprising:
a plurality of foot sole templates, wherein each template varies in shape; and
wherein at least one template has at least one selecting means for selecting strap positioning.

2. The system of claim 1, wherein the foot templates are printed on paper.

3. The system of claim 1, wherein the foot templates are formed from plastic.

4. The system of claim 1, wherein the selecting means is a plurality of apertures.

5. The system of claim 1, wherein the selecting means is a plurality of position identifiers.

6. A method of customizing sandals for a user, comprising:
presenting a user with a plurality of foot sole templates, wherein each template varies in shape;
selecting the shape and size that is optimal for the user; and
manufacturing the sandal.

7. The method of claim 6, further comprising a selecting means for strap positioning.

8. The method of claim 7, wherein the selecting means is a plurality of apertures.

9. The method of claim 7, wherein the selecting means is a plurality of position identifiers.

10. The method of claim 6, wherein the plurality of foot sole templates are overlaid one with another as a single template.

11. A method of customizing a sandal order, comprising:
using an electronic device to view or download at least one foot sole template;
selecting the optimal template for size and shape;
selecting strap positioning using a selecting means; and
placing the order online.

12. The method of claim 11, wherein the electronic device is a personal computer.

13. The method of claim 11, wherein the electronic device is a smartphone.

14. The method of claim 11, wherein a user prints out the templates to make a selection for size, shape, and strap positioning.

15. The method of claim 11, wherein the selecting means is at least one aperture.

16. The method of claim 11, wherein the selecting means is a plurality of position identifiers.

17. The method of claim 16, wherein the position identifiers are numbers.
